(19) United States
(12) Patent Application Publication
(10) Pub. No.: US 2020/0295340 A1
(43) Pub. Date: Sep. 17, 2020

(54) SEALED BATTERY AND MANUFACTURING METHOD THEREOF

(71) Applicant: TOYOTA JIDOSHA KABUSHIKI KAISHA, Toyota-shi (JP)

(72) Inventors: Shinya OMURA, Nagakute-shi (JP); Masashi KATO, Konan-shi (JP); Mizuho MATSUMOTO, Toyota-shi (JP)

(21) Appl. No.: 16/804,400

(22) Filed: Feb. 28, 2020

(30) Foreign Application Priority Data
Mar. 11, 2019 (JP) 2019-044181

(51) Int. Cl. H01M 2/26; H01M 2/30; H01M 2/02; H01M 10/04; H01M 10/0585; H01M 10/0525; B23K 20/10

(52) U.S. Cl. CPC H01M 2/26; H01M 2/30; H01M 2/0212; B23K 20/10; H01M 10/0585; H01M 10/0525; H01M 10/0413

(57) ABSTRACT

A sealed battery disclosed here comprises an electrode body comprising a positive electrode collector and a negative electrode collector, collector tabs for external connection bonded to the corresponding collector, and a case. Both of bonded portions of the positive and the negative electrode collectors and the positive and negative electrode collector tabs are in the case. At least one of the positive and the negative electrode collectors and the collector tab bonded to the corresponding electrode are made of metals different from each other. An intermetallic compound present at a bonded interface between the collector and the connector tab and is made of the metals different from each other has a maximum diameter of smaller than 1 μm under a transmission electron microscope observation.

### CROSS-REFERENCE TO RELATED APPLICATIONS

Priority is claimed on Japanese Patent Application No. 2019-044181, filed Mar. 11, 2019, the content of which is incorporated herein by reference.

### BACKGROUND OF THE INVENTION

### 1. Field of the Invention

The present invention relates to a sealed battery and a manufacturing method thereof. Specifically, the present invention relates to a collecting structure of a sealed battery including a laminate film battery case.

### 2. Description of the Related Art

Lithium ion secondary batteries have recently been desirably used as a so-called portable power supply for personal computers, mobile terminals and the like and additionally as a power supply for driving vehicles because they are lighter and have a higher energy density than existing secondary batteries. It is expected that lithium ion secondary batteries will be increasingly popularized for, particularly, a power supply with high power for driving vehicles such as an electric vehicle (EV), a hybrid vehicle (HV) and a plug-in hybrid vehicle (PHV).

Meanwhile, as a form of such a lithium ion secondary battery, a battery (sealed battery) in a sealed structure in which an electrode body including electrode sheets for a positive electrode and a negative electrode is contained in a case (e.g., laminate film battery case), and the positive electrode and the negative electrode collectors constituting the electrode sheets and collector tabs for external connection which are connected to the collectors are made of different metals, as disclosed in Japanese Patent Application Publication No. 2017-123306, for example, has been conceivable.

In a sealed battery having such characteristics, since collectors and collector tabs made of different metals are bonded using means such as welding, brittle intermetallic compounds may be made at a portion at which the different metals (e.g., copper and aluminum, or the like) are bonded to each other.

However, generation of intermetallic compounds is not desirable because it may cause decrease in the strength of bonded portions of the collectors and the collector tabs.

In addition, generation of intermetallic compounds can be enhanced according to application of high heat to the bonded portion of the different metals and thus methods of bonding the different metals are limited. For example, Japanese Patent Application Publication No. 2017-123306 describes difficulties in use of heating fusion bonding for different metal bonding from the viewpoint of generation of a eutectic structure (intermetallic compounds) and the like and discloses a technique of applying ultrasonic welding instead of heating fusion bonding.

### SUMMARY

If ultrasonic welding can be used for bonding different metals as described above, high fusion heat generated when arc welding, laser welding and the like are used can be prevented from being applied to a bonded portion of different metals, and thus it is possible to reduce intermetallic compounds at the corresponding contact portion and improve the strength of the bonded portion of the different metals.

However, even if ultrasonic welding is used as a bonding means, generation of intermetallic compounds may still be promoted depending on conditions for application of ultrasonic energy (i.e., vibration energy of ultrasonic waves) during bonding. Thus, sufficient strength of the bonded portion of the different metals may not be secured and furthermore there is a concern that reliability of a sealed battery may not be maintained.

Accordingly, the present invention is devised to promote improvement of the strength of the aforementioned bonded portion of different metals and an object of the present invention is to provide a sealed battery in which the strength of a bonded portion of different metals is improved when at least one of a positive electrode collector and a negative electrode collector and at least one collector tab connected to the corresponding collect(s) are formed of metals different from each other. In addition, another object is to provide a method of manufacturing such a sealed battery.

The inventor discovered that a maximum diameter of intermetallic compounds formed at a bonded interface of different metals is considerably reduced by adjusting the magnitude of ultrasonic energy applied when the different metals are ultrasonic welded and thus the strength of the bonded portion of the different metals being significantly improved and perfected the present invention.

That is, to realize the aforementioned object, the present invention provides a sealed battery comprising an electrode body comprising a sheet-shaped positive electrode collector and a sheet-shaped negative electrode collector, a positive electrode collector tab and a negative electrode collector tab for external connection, the positive electrode collector tab and the negative electrode collector tab respectively bonded to a part of the positive electrode collector and a part of the negative electrode collector, and a laminate film battery case containing the electrode body.

Both of a bonded portion of the positive electrode collector and the positive electrode collector tab and a bonded portion of the negative electrode collector and the negative electrode collector tab are in the laminate film battery case. At least one of the positive electrode and the negative electrode collectors and the collector tab bonded to the corresponding electrode are made of metals different from each other. The collector and the collector tab made of the metals different from each other may be bonded to each other by performing ultrasonic welding under predetermined conditions which will be described later. An intermetallic compound present at a bonded interface between the collector and the collector tab made of the metals different from each other has a maximum diameter of smaller than 1 μm under a transmission electron microscope (TEM) observation.

In the sealed battery having such a configuration, a maximum diameter of intermetallic compounds, formed at a metal interface (bonded interface) between a collector and a collector tab on the same electrode side are made of different metals, in TEM observation (TEM image) is limited to a size of smaller than 1 μm. As a result, a high strength (tensile strength or the like) of the bonded portion can be realized.

In a preferred aspect of the sealed battery disclosed here, the positive electrode collector is made of aluminum and the positive electrode collector tab is made of copper. Further, in another preferred aspect, the negative electrode collector is made of copper and the negative electrode collector tab is made of aluminum.

In the sealed battery of this aspect, although the bonded portions on the positive electrode side and/or the negative electrode side are made of different metals that are copper and aluminum, formation of intermetallic compounds at the bonded portions (bonded interfaces) is prevented and consequently a high tensile strength at the bonded portions can be realized.

Further, the present invention provides a method of manufacturing the sealed battery disclosed here. That is, the manufacturing method disclosed here is a method of manufacturing a sealed battery comprising an electrode body comprising a sheet-shaped. positive electrode collector and a sheet-shaped negative electrode collector, a positive electrode collector tab and a negative electrode collector tab for external connection, the positive electrode collector tab and the negative electrode collector tab respectively bonded to a part of the positive electrode collector and a part of the negative electrode collector, and a laminate film battery case containing the electrode body.

In the manufacturing method, at least one of the positive and the negative electrode collectors and the collector tab bonded to the corresponding electrode are made of metals different from each other. In addition, collectors and collector tabs made of different metals are bonded to each other through ultrasonic welding. In this manufacturing method, an ultrasonic energy level applied to the bonded portion of the collector and the collector tab during such ultrasonic welding is set such that a maximum diameter of an intermetallic compounds formed at a bonded interface between the collector and the collector tab in TEM observation (TEM image) is smaller than 1 μm.

In the manufacturing method having such a configuration, it is possible prevent fusion heat from being applied to a bonded portion of different metals by bonding different metals through ultrasonic welding using a relatively low ultrasonic energy level. In addition, it is possible to suppress formation of intermetallic compounds having a maximum diameter equal to or greater than 1 μm in TEM observation at bonded interfaces between collectors and a collector tab formed of different metals by adjusting an amount of applied ultrasonic energy. Accordingly, formation of intermetallic compounds at bonded portion (bonded interfaces) of a collector and a collector tab made of different metals is prevented and consequently, a high tensile strength at the bonded portion can be realized.

In a preferred aspect of the manufacturing method disclosed here, the positive electrode collector is made of aluminum, the positive electrode collector tab is made of copper, and the positive electrode collector and the positive electrode collector tab are bonded to each other using ultrasonic welding at an ultrasonic energy level of 200 J or smaller is applied. Further, in another preferred aspect, the negative electrode collector is made of copper, the negative electrode collector tab is made of aluminum, and the negative electrode collector and the negative electrode collector tab are bonded to each other using ultrasonic welding in which an ultrasonic energy of equal to or smaller than 200 J is applied.

It is possible to improve the strength (tensile strength or the like) of a bonded portion of different metals that are copper and aluminum by forming the collectors and the collector tabs using the aforementioned metals and performing ultrasonic welding thereon by applying an ultrasonic energy of equal to or smaller than 200 J thereto.

### BRIEF DESCRIPTION OF THE DRAWINGS

FIG. 1 is a cross-sectional view schematically showing a sealed battery according to the present embodiment;

FIG. 2A is a TEM image showing a bonded interface of the Working Example in which a bonded portion is formed by ultrasonic welding in which an ultrasonic energy of equal to or smaller than 200 J was applied;

FIG. 2B is a TEM image obtained by observing the bonded interface of the Working Example shown in FIG. 2A with a higher magnification;

FIG. 2C is a TEM image showing a bonded interface of comparative example 1 in which a bonded portion has been formed by ultrasonic welding in which an ultrasonic energy of 400 J was applied;

FIG. 2D is a TEM image showing a bonded interface of comparative example 2 in which a bonded portion has been formed by ultrasonic welding in which an ultrasonic energy of 420 J was applied; and

FIG. 2E is a TEM image showing a bonded interface of comparative example 3 in which a bonded portion has been formed by ultrasonic welding in which an ultrasonic energy of 450 J was applied.

### DETAILED DESCRIPTION OF THE PREFERRED EMBODIMENTS

Hereinafter, an embodiment of the present invention is described with reference to the drawings. In the drawings described below, members and parts which exhibit the same actions are denoted by the same signs and redundant description is omitted or simplified. In addition, dimensional relations (length, width, thickness and the like) in the drawings do not reflect actual dimensional relations. Furthermore, matters other than particularly mentioned in the present description and necessary to implement the present invention may be ascertained as matters designed by those skilled in the art based on the conventional technology in the relative area.

In the present description, a “secondary battery” refers to a general power storage device which can be repeatedly charged and discharged and includes capacitors (i.e., physical cells) such as an electrical double layer capacitor in addition to so-called storage batteries chemical cells) such as a lithium ion secondary battery, a nickel-hydride battery and a nickel-cadmium battery. The “lithium ion secondary battery” refers to a secondary battery which uses lithium ions as electrolyte ions and is charged and discharged according to movement of lithium ions between a positive electrode and a negative electrode and is not limited to specific materials (e.g., species of a positive electrode active material and a solvent constituting a nonaqueous electrolyte), battery capacities and forms. A “sealed battery” refers to a battery having a structure in which an opening portion of the battery case is sealed and the airtightness of the inside of the battery case is maintained at a desired level in ordinary usage. In addition, a “solid-state battery” refers to a battery including a solid electrolyte.

Furthermore, an “intermetallic compound” in the present description is a solid substance composed of two or more metallic elements and refers to compounds having clearly different structures and properties from their constituent metals.

In addition, a “maximum diameter” in TEM observation with respect to pieces of intermetallic compounds present at a bonded interface of the aforementioned bonded portion refers to a maximum (longest) diameter from among straight diameters connecting two arbitrary circumferential points at individual locations on pieces of intermetallic compounds observed in a TEM image which represents the bonded interface.

Furthermore, an “active material” in the present description refers to a material (active material) which can reversibly occlude and release (typically insert and remove) chemical species (i.e., lithium ions, for example) that are charge carriers in a secondary battery (e.g., a lithium ion secondary battery).

Hereinafter, the present invention will be described in detail by exemplifying a solid-state lithium ion secondary battery in a structure in Which a flat electrode body is contained in a laminate film battery case as a form of a sealed battery disclosed here. Meanwhile, the present invention is not intended to be limited to such an embodiment.

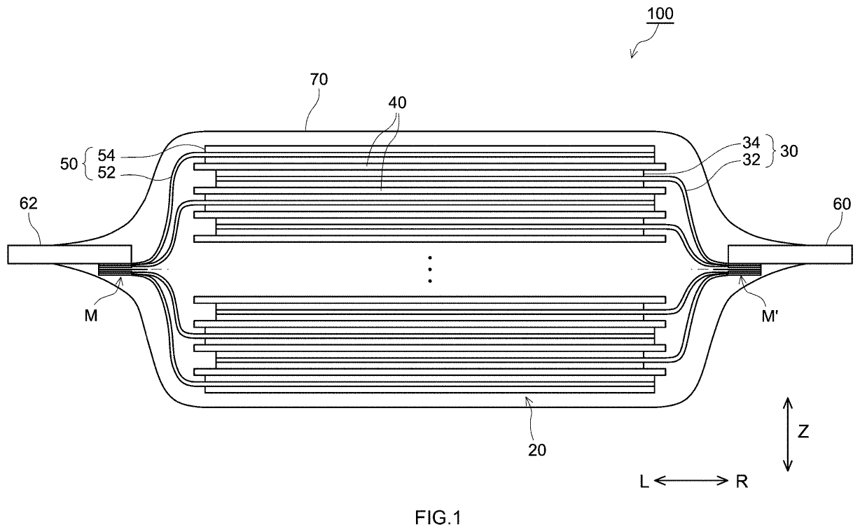

FIG. 1 is a cross-sectional view of an overall configuration of a sealed battery 100 according to the present embodiment. As shown, the sealed battery 100 includes a fiat electrode body 20 and a laminate film battery case 70. In addition, the electrode body 20 includes positive electrode sheets 30 and negative electrode sheets 50, and the positive electrode sheets 30 and the negative electrode sheets 50 are laminated in a direction perpendicular to the sheet width surface (direction of the arrow Z in FIG. 1) by being alternately superimposed with solid electrolytic layers 40 therebetween.

Each positive electrode sheet 30 includes a positive electrode collector 32 that is a sheet in a rectangular shape and a positive electrode active material layer 34 formed on the positive electrode collector 32. In addition, each negative electrode sheet 50 includes a negative electrode collector 52 that is a sheet in a rectangular shape and a negative electrode active material layer 54 formed on the negative electrode collector 52.

As shown in FIG. 1, edges of the plurality of laminated positive electrode collectors 32 at which the positive electrode active material layer 34 is not formed are superimposed in a right direction (direction R) in FIG. 1 and additionally superimposed on a part of a positive electrode collector tab 60 for external connection to form a bonded portion M′ at which they are bonded to each other by a welding method which will be described later.

Similarly, edges of the plurality of laminated negative electrode collectors 52 at which the negative electrode active material layer 54 is not formed are superimposed in a left direction (direction L) in FIG. 1 and additionally superimposed on a part of a negative electrode collector tab 62 for external connection to form a bonded portion M at which they are bonded to each other. In these positive electrode and negative electrode sheets 30 and 50, both the bonded portions M and M′ formed from the collectors and collector tabs are formed inside of the case 70. Further, the other edges of the collector tabs 60 and 62 project from the case 70 outside of the battery and arranged to be electrically connectable to an external circuit, device or the like. Such an external connection structure is not a part which characterizes the present invention and thus detailed description thereof is omitted.

At least one of the positive electrode collector and the negative electrode collector and at least one collector tab on the corresponding electrode side(s) to and connected to the at least one collector are formed of different metals. For example, when the positive electrode collector 32 and the positive electrode collector tab 60 are made of different metals, the negative electrode collector 52 and the negative electrode collector tab 62 may be made of different metals or the same metal. On the other hand, when the negative electrode collector 52 and the negative electrode collector tab 62 are made of different metals, the positive electrode collector 32 and the positive electrode collector tab 60 may be made of different metals or the same metal.

As the positive electrode collectors 32, metallic positive electrode collectors used as positive electrode collectors of this kind of battery can be used without particular limitation. Typically, the positive electrode collectors 32 may be made of a metal material such as aluminum, nickel, titanium or stainless steel and the like having high conductivity. Particularly, aluminum (e.g., aluminum foil) may be desirable.

In addition, as the positive electrode collector tab 60, a known conventional metallic positive electrode collector tab can be used without particular limitation and, for example, a metallic material such as copper or aluminum may be conceivable as the material thereof

As the negative electrode collectors 52, metallic negative electrode collectors used as negative electrode collectors of this kind of battery can be used without particular limitation. Typically, copper, a copper alloy, nickel, titanium, stainless steel and the like which have high conductivity can be used, for example. Particularly, copper (e.g., copper foil) may be desirable.

In addition, as the negative electrode collector tab 62, a known conventional metallic negative electrode collector tab can be used without particular limitation and, for example, a metallic material such as copper or aluminum may be conceivable as the material thereof.

When the bonded portion M and/or the bonded portion M′ are formed by bonding different metals, an intermetallic compound having both the metals as constituent elements may be formed at a bonded interface between different metals. For example, when different metals are aluminum and copper, CuAl₂ or the like can be conceivable as an intermetallic compound formed at the interface therebetween. When a large amount of an intermetallic compound having a large size (e.g., a maximum diameter of equal to or greater than 1 μm) is formed at a bonded interface during ultrasonic welding of collectors and a collector tab, there is a concern of decrease in the mechanical strength (tensile strength or the like) of the bonded portion because such an intermetallic compound is brittle.

Although a method for measuring the maximum diameter of intermetallic compounds present at the bonded interface is not particularly limited, TEM image observation of a cut section (i.e., a cut section having a bonded interface) of a bonded portion using a transmission electron microscope (TEM) is conceivable as a suitable means. Here, it may be desirable that a maximum diameter of intermetallic compounds present at the bonded interface is smaller than 1 μm at the bonded portion M and/or the bonded portion M′ (FIG. 1) formed by bonding different metals in observation using TEM. It may be more desirable if the maximum diameter is smaller than 0.7 μm, further desirable if the maximum diameter is smaller than 0.5 μm, and particularly desirable if the maximum diameter is smaller than 0.3 μm. It is possible to realize a practically sufficiently high mechanical strength for the bonded portion M and/or the bonded portion M′ by maintaining the maximum diameter of intermetallic compounds at a low level, as described above.

The positive electrode active material layer 34 includes a positive electrode active material that is a main constituent and may include a conductive material, a binder and/or a solid electrolyte or the like which will be described later.

A lithium-containing compound (e.g., lithium-transition metal composite oxide) which is a material capable of occluding and releasing lithium ions and includes elemental lithium and one or two or more transition metal elements can be used as the positive electrode active material without particular limitation. As a suitable example, a lithium-transition metal oxide having a layered rock-salt or spinel crystal structure is conceivable. Such a lithium-transition metal oxide can be, for example, a ternary lithium-containing composite oxide such as lithium-nickel composite oxides (e.g., LiNiO₂), lithium-cobalt composite oxides (e.g., LiCoO₂), lithium-manganese composite oxides (e.g., LiMn₂O₄) or lithium-nickel-cobalt-manganese composite oxides (e.g., LiNi_{1/3}Co_{1/3}Mn_{1/3}O₂).

Furthermore, phosphates containing lithium and a transition metal element as constituent metal elements, such as lithium-manganese phosphate (e.g., LiMnPO₄) and lithium-iron phosphate (e.g., LiFePO₄), may be used.

As a conductive material, those used in conventional lithium ion batteries may be desirable and a carbon black such as acetylene black or Ketjen black and carbon fibers such as carbon nanotubes may be conceivable, for example. In addition, as a binder, those used in conventional lithium ion secondary batteries may be desirable and styrene-butadiene rubber (SBR), polyvinylidene fluoride (PVdF), butyl rubber (BR), acrylonitrile-butadiene rubber (ABR) or the like is conceivable, for example.

The negative electrode active material layer 54 may include a negative electrode active material that is a main constituent and include a conductive material, a binder and/or a solid electrolyte or the like which will be described later.

As a negative electrode active material, a graphite-based material such as natural graphite (black lead) or artificial graphite, a carbon-based negative electrode active material such as graphite, mesocarbon microbeads or carbon black, silicon, tin, and the like, or a composite thereof may be conceivable, for example.

As a conductive material and a binder, the above-described ones can be used. In addition, an additive such as a thickener may be appropriately used, and carboxymethylcellulose (CMC) or methylcellulose (MC) is conceivable as a thickener, for example.

The solid electrolytic layer 40 includes at least a solid electrolyte. For example, a sulfide-based solid electrolyte and an oxide-based solid electrolyte may be conceivable as a solid electrolyte. As examples of the sulfide-based solid electrolyte, glass or glass ceramics such as Li₂S-SiS₂ species, Li₂S-P₂S₃ species, Li₂S-P₂S₅ species, Li₂S-GeS₂ species and Li₂S-B₂S₃ species may be conceivable. As examples of the oxide-based electrolyte, various oxides having a NASICON structure, a garnet structure or a perovskite structure may be conceivable.

The case 70 is in the form of a bag and is sealed through heat welding (heat sealing) of the circumference of an accommodation space for accommodating the electrode body 20.

As the case 70, the same laminate film battery case as used for this kind of sealed battery can be appropriately employed. For example, a laminate film having a conventional known multilayer (e.g., 3-layer or 4-layer) structure can be used.

The electrode body 20 can be manufactured using the aforementioned materials and members, and the sealed battery (solid-state battery) 100 according to the present embodiment can be constructed. A process for manufacturing the sealed battery 100 according to the present embodiment may be the same as the process for manufacturing a conventional sealed battery. However, it is characterized in that a collector and a collector tab connected to the collector are made of different metals and different metals are bonded to each other using ultrasonic welding to form a bonded portion in at least either of a positive electrode or a negative electrode.

Conditions for ultrasonic welding can be appropriately adjusted and implemented depending on compositions of target metals. For example, adjustment within an energy range of 10 to 200 J (desirably 30 to 200 J) typically, an amplitude range of 25% to 90% (desirably 30% to 90%) typically, and a welding pressure range of 500 N or smaller (desirably 300 N or smaller) typically is exemplified. Within these ranges, an ultrasonic energy can be set (determined) such that a maximum diameter of intermetallic compounds generated at a bonded interface between a collector and a collector tab made of different metals in transmission microscope observation is smaller than 1 μm.

For example, when the positive electrode collector 32 is made of aluminum, the positive electrode collector tab 60 is made of copper, and the positive electrode collector 32 and the positive electrode collector tab 60 are bonded to each other, it is desirable that an ultrasonic energy is equal to or smaller than 200 J. In addition, when the negative electrode collector 52 is made of copper, the negative electrode collector tab 62 is made of aluminum, and the negative electrode collector 52 and the negative electrode collector tab 62 are bonded to each other, it is desirable that an ultrasonic energy is equal to or smaller than 200 J. It is possible to improve the mechanical strengths of the bonded portion M and/or the bonded portion M′ by adjusting an amount of ultrasonic energy applied in ultrasonic welding to the aforementioned level to thereby maintain the reliability of the sealed battery 100 according to the present embodiment.

Meanwhile, when the bonded portion M or the bonded portion M′ is formed using the same metal, a means for bonding the metal is not particularly limited and any of conventional known bonding means such as ultrasonic welding, resistance welding and laser welding can be employed.

Hereinafter, some test examples related to the present invention will be described but the present invention is not intended to be limited to such test examples.

In the present test examples, an aluminum piece and a copper piece were prepared and 4 test pieces were manufactured under different ultrasonic energy application conditions. Hereinafter respective tests are described in detail.

### Text Example 1: Manufacture of Test Pieces

### Working Example

A plate-shaped aluminum piece (pure aluminum, Al11050) having a shorter side of 25 mm in length, a longer side of 50 mm in length and a thickness of 1 mm, and a plate-shaped copper piece (pure copper, Cu1100) having a shorter side of 25 mm in length, a longer side of 50 mm in length and a thickness of 1 mm were prepared. These metal pieces were partially overlapped in the longer-side direction and ultrasonic welding was performed on these metal pieces by applying an ultrasonic energy of 200 J or smaller thereto to manufacture a test piece according to an embodiment. Meanwhile, specific ultrasonic welding conditions were set to an amplitude of 90%, a welding pressure of 300 N and a bonding temperature of room temperature (25° C. to 27° C.).

### Comparative Example 1

A test piece according to comparative example 1 was manufactured in the same way as those of Working Example except that the magnitude of an ultrasonic energy applied when ultrasonic welding was performed on the aluminum piece and the copper piece was 400 J.

### Comparative Example 2

A test piece according to comparative example 2 was manufactured in the same way as those of Working Example except that the magnitude of an ultrasonic energy applied when ultrasonic welding was performed on the aluminum piece and the copper piece was 420 J.

### Comparative Example 3

A test piece according to comparative example 3 was manufactured in the same way as those of Working Example except that the magnitude of an ultrasonic energy applied when ultrasonic welding was performed on the aluminum piece and the copper piece was 450 J.

### Test 2: Observation of Bonded Interface

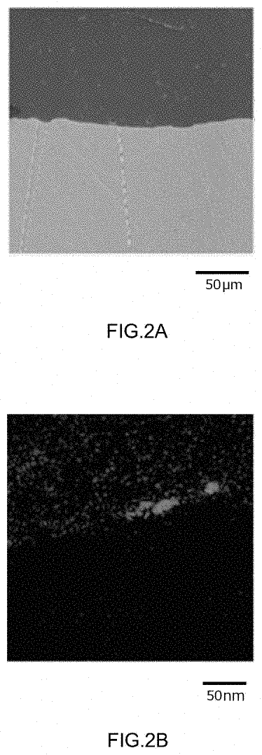

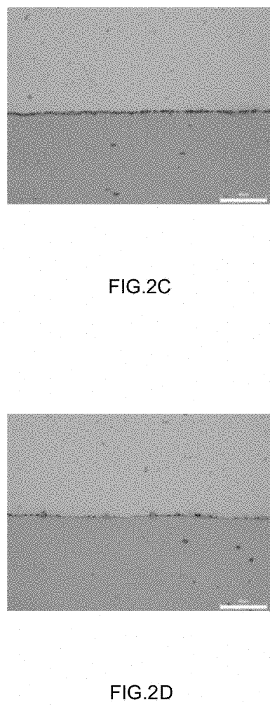

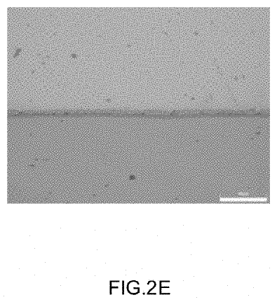

Intermetallic compounds formed at bonded interfaces of the 4 test pieces manufactured in test example I were observed using TEM and maximum diameters of intermetallic compounds were measured. Results are shown in FIGS. 24 to 2E and Table 1.

TABLE 1

| | Working | Comparative | Comparative | Comparative |
|---|---|---|---|---|
| | Example | example 1 | example 2 | example 3 |
| Ultrasonic energy | <200 | 400 | 420 | 450 |
| (J) | | | | |
| Amplitude (%) | 90 | 90 | 90 | 90 |
| Welding pressure | 300 | 300 | 300 | 300 |
| (N) | | | | |
| Average size of | Nano size | 4.9 | 5.5 | 7.3 |
| intermetallic | | | | |
| compounds (μm) | | | | |

FIG. 24 and FIG. 2B are TEM images of the bonded interface of the Working Example. At the bonded interface of the Working Example, the maximum diameter of intermetallic compounds was a nano size in TEM observation (refer to Table 1). FIG. 2C, FIG. 2D and FIG. 2E respectively show TEM images of the bonded interfaces of comparative examples 1 to 3. At the bonded interfaces of comparative examples 1 to 3. all of the maximum diameters of intermetallic compounds were greater than 1 μm in TEM observation (refer to Table 1).

Accordingly, it was ascertained that the maximum diameters of intermetallic compounds at the bonded interfaces of the test pieces are reduced to nano sizes in electron microscope observation by setting an amount of ultrasonic energy to be applied to 200 J or smaller,

### Test 3: Tensile Test

Tensile tests of stretching an aluminum piece and a copper piece bonded to each other such that they separated from each other were performed on the 4 test pieces manufactured in test example 1. Here, a fracture form of bonding of the aluminum piece and the copper piece and a fracture load as a bonding strength (N) were measured. Results are shown in Table 2.

TABLE 2

| | Working | Comparative | Comparative | Comparative |
|---|---|---|---|---|
| | Example | example 1 | example 2 | example 3 |
| Fracture | Mother | Bonded | Bonded | Bonded |
| form | material | interface | interface | interface |
| Bonding | 437 | 176 | 220 | 201 |
| strength | | | | |
| (N) | | | | |

As shown in Table 2, it was confirmed that the bonding strength of the aluminum piece and the copper piece was considerably improved in the embodiment as compared to Comparative examples 1 to 3 with regard to results of measurement of the fracture form and the bonding strength of each test piece.

Accordingly, it was ascertained that the strength of the bonded portion is significantly improved in the test pieces according to the Working Example in which the maximum diameter of intermetallic compounds formed at the bonded interface between the aluminum piece and the copper piece during ultrasonic welding using an ultrasonic energy of 200 J or smaller becomes a nano size in TEM observation.

Although specific examples of the present invention have been described above, these are merely examples and do not limit the claims. The technology described in the claims includes various modifications and changes of the specific examples exemplified above.

For example, although a solid-state lithium ion secondary battery has been described as a specific example of the present invention, a secondary battery using a nonaqueous electrolyte as an electrolyte without including a solid electrolyte may be manufactured. In addition, a sodium ion secondary battery or a magnesium ion secondary battery may be manufactured. In such a case, the same effects as those exemplified above can also be obtained.

What is claimed is:

1. A sealed battery comprising:
an electrode body comprising a sheet-shaped positive electrode collector and a sheet-shaped negative electrode collector;
a positive electrode collector tab and a negative electrode collector tab for external connection, the positive electrode collector tab and the negative electrode collector tab respectively bonded to a part of the positive electrode collector and a part of the negative electrode collector; and
a laminate film battery case containing the electrode body,
wherein both of a bonded portion of the positive electrode collector and the positive electrode collector tab and a bonded portion of the negative electrode collector and the negative electrode collector tab are in the laminate film battery case, and
at least one of the positive and the negative electrode collectors and the collector tab bonded to the corresponding electrode are made of metals different from each other,
an intermetallic compound present at a bonded interface between the collector and the collector tab made of the metals different from each other has a maximum diameter of smaller than 1 μm under a transmission electron microscope observation.

2. The sealed battery according to claim 1, wherein the positive electrode collector is made of aluminum and the positive electrode collector tab is made of copper.

3. The sealed battery according to claim 1, wherein the negative electrode collector is made of copper and the negative electrode collector tab is made of aluminum.

4. A method of manufacturing a sealed battery comprising:
an electrode body comprising a sheet-shaped positive electrode collector and a sheet-shaped negative electrode collector;
a positive electrode collector tab and a negative electrode collector tab for external connection, the positive electrode collector tab and the negative electrode collector tab respectively bonded to a part of the positive electrode collector and a part of the negative electrode collector; and
a laminate film battery case containing the electrode body,
wherein at least one of the positive and the negative electrode collectors and the collector tab bonded to the corresponding electrode are made of metals different from each other, the method comprising:
bonding the collectors and the collector tabs made of the metals different from each other using ultrasonic welding;
wherein an ultrasonic energy level applied to a bonded portion of the collector and the collector tab during the ultrasonic welding is set such that an intermetallic compound generated at a bonded interface between the collector and the collector tab has a maximum diameter of smaller than 1 μm under transmission electron microscope observation.

5. The method according to claim 4, wherein the positive electrode collector is made of aluminum, the positive electrode collector tab is made of copper, and the positive electrode collector and the positive electrode collector tab are bonded to each other using ultrasonic welding at an ultrasonic energy level of 200 J or smaller.

6. The method according to claim 4, wherein the negative electrode collector is made of copper, the negative electrode collector tab is made of aluminum, and the negative electrode collector and the negative electrode collector tab are bonded to each other using ultrasonic welding at an ultrasonic energy level of 200 J or smaller.
